(19) United States
(12) Patent Application Publication
(10) Pub. No.: US 2019/0017378 A1
(43) Pub. Date: Jan. 17, 2019

(54) Natural Resource Reservoir Charging

(71) Applicant: SCHLUMBERGER TECHNOLOGY CORPORATION, Sugar Land, TX (US)

(72) Inventor: Armin I Kauerauf, Aachen (DE)

(21) Appl. No.: 16/068,380

(22) PCT Filed: Jan. 10, 2017
(86) PCT No.: PCT/US2017/012793

§ 371 Date: Jul. 6, 2018

Related U.S. Application Data
(60) Provisional application No. 62/277,875, filed on Jan. 12, 2016.

(51) Int. Cl. E21B 49/08; G01V 99/00

(52) U.S. Cl. CPC E21B 49/087; E21B 49/003; G01V 99/005

(57) ABSTRACT

A method for managing a reservoir, including: receiving a plurality of geological data values associated with the reservoir; identifying a plurality of catchment areas associated with the reservoir based on the plurality of geological data values; identifying a plurality of spill points for the reservoir based on the plurality of catchment areas; identifying a plurality of reservoir traps for the reservoir based on the plurality of spill points and the plurality of catchment areas; and determining a plurality of effective trap sizes and a plurality of effective catchment area sizes based on the plurality of reservoir traps and the plurality of catchment areas.

### BACKGROUND

In gas and oil exploration, potential drilling and production sites (i.e., “prospects”) may be ranked by chance of success for finding gas or oil. This chance may be calculated by convolution of several different geological quantities such as reservoir quality, seal quality, the probability of charging the reservoir from a source rock and the maturity of the source rock. In general, oil and gas reservoirs may include reservoir traps (e.g., oil and gas traps), where such traps generally refer to a subsurface pool of hydrocarbons enclosed in porous or fractured rock formations.

In general, exploration for oil, gas, and other natural resources and extraction thereof may make use of various characteristics of subsurface formations. Therefore, a continuing need exists for improved analysis systems and methods for oil and gas exploration and extraction.

### SUMMARY

In general, in one aspect, embodiments relate to a method for managing a reservoir. The method includes: receiving a plurality of geological data values associated with the reservoir; identifying a plurality of catchment areas associated with the reservoir based on the plurality of geological data values; identifying a plurality of spill points for the reservoir based on the plurality of catchment areas; identifying a plurality of reservoir traps for the reservoir based on the plurality of spill points and the plurality of catchment areas; and determining a plurality of effective trap sizes and a plurality of effective catchment area sizes based on the plurality of reservoir traps and the plurality of catchment areas.

In general, in one aspect, embodiments relate to a system for managing a reservoir. The system comprises: a processor; a repository storing a plurality of geological data values associated with the reservoir; a reservoir engine executing on the processor that: identifies a plurality of catchment areas associated with the reservoir based on the plurality of geological data values; identifies a plurality of spill points for the reservoir based on the plurality of catchment areas; identifies a plurality of reservoir traps for the reservoir based on the plurality of spill points and the plurality of catchment areas; and determines a plurality of effective trap sizes and a plurality of effective catchment area sizes based on the plurality of reservoir traps and the plurality of catchment areas; and a model generator that: generates a basin model associated with the reservoir that includes an indicator of the plurality of effective trap sizes associated with the reservoir and an indicator of the plurality of effective catchment area sizes; and generates a visualization of the basin model for output on a display.

In general, in one aspect, embodiments relate to a non-transitory computer readable medium (CRM) storing instructions for managing a reservoir. The instructions comprises functionality for: receiving a plurality of geological data values associated with the reservoir; identifying a plurality of catchment areas associated with the reservoir based on the plurality of geological data values; identifying a plurality of spill points for the reservoir based on the plurality of catchment areas; identifying a plurality of reservoir traps for the reservoir based on the plurality of spill points and the plurality of catchment areas; and determining a plurality of effective trap sizes and a plurality of effective catchment area sizes based on the plurality of reservoir traps and the plurality of catchment areas; determining an economic value of the reservoir based on the plurality of effective trap sizes and the plurality of effective catchment area sizes.

Other aspects will be apparent from the following description and the appended claims.

### BRIEF DESCRIPTION OF DRAWINGS

FIGS. 1.1-1.4 illustrate simplified, schematic views of an oilfield having subterranean formations containing reservoirs therein in accordance with one or more embodiments.

FIG. 2 illustrates a schematic view, partially in cross section of an oilfield having a plurality of data acquisition tools positioned at various locations along the oilfield for collecting data from the subterranean formations in accordance with one or more embodiments.

FIG. 3 illustrates a production system for performing one or more oilfield operations in accordance with one or more embodiments.

FIG. 4 illustrates a surface unit in accordance with one or more embodiments.

FIGS. 5-7 provide flowcharts in accordance with one or more embodiments.

FIG. 8 provides a depth view of an example oil and gas reservoir.

FIG. 9 provides a depth view of an example oil and gas reservoir.

FIG. 10 provides a depth view of an example oil and gas reservoir.

FIG. 11 provides an example map of geological features mapped to a chance of success scale for an oil and gas reservoir.

FIG. 12 provides an example graphical user interface in accordance with one or more embodiments.

FIG. 13.1 shows a computer system in accordance with one or more embodiments.

FIG. 13.2 shows a network in accordance with one or more embodiments.

### DETAILED DESCRIPTION

Specific embodiments will now be described in detail with reference to the accompanying figures. Like elements in the various figures are denoted by like reference numerals for consistency.

In the following detailed description of embodiments, numerous specific details are set forth in order to provide a more thorough understanding of the embodiments. However, it will be apparent to one of ordinary skill in the art that various embodiments may be practiced without these specific details. In other instances, well-known features have not been described in detail to avoid unnecessarily complicating the description.

One or more embodiments relate to a method, system, and non-transitory computer readable medium (CRM) storing instructions for managing a reservoir. Specifically, effective trap sizes and effective catchment area sizes associated with the oil and gas reservoir are determined. In general, each effective trap size and the effective catchment area size may be included in a model of the oil and gas reservoir. Consistent with one or more embodiments, each effective trap size and the effective catchment area size may be used in determining a probability of success associated with the oil and gas reservoir for extraction of hydrocarbons, determining an economic value associated with the oil and gas reservoir, ranking the oil and gas reservoir relative to other oil and gas reservoirs, and/or other such processes that may be performed when analyzing oil and gas reservoirs for prospecting.

In general, an oil and gas reservoir may include one or more reservoir traps, where a reservoir trap generally corresponds to a subsurface pool of hydrocarbons enclosed in porous or fractured rock formations. The reservoir trap may correspond to a structural trap in the form of a smooth anticlinal layer structure, a trap in a faulted reservoir, a trap touching one or more faults of the same or different types (e.g., sealing faults), etc. A reservoir trap may form as a result of changes in a subsurface, where such changes may block the upward migration of hydrocarbons, which may lead to the formation of an oil and gas reservoir. In general, each reservoir trap is associated with a catchment area (also called a drainage area). In the case of many trap types (e.g., structural traps), the upward migration is due to the fact that the oil and gas are lighter than water. In the case of other trap types (e.g., hydrodynamic traps), the upwards migration is against overall fluid potential (i.e., overpressure gradients). The catchment area is effectively the channel in which hydrocarbons migrate upwards to reach the reservoir and afterwards migrate laterally into the same trap. Accordingly, the trap may be considered a container for storing hydrocarbons while the catchment area may be considered the access door or influx gate that leads into trap. A structural spill point generally corresponds to a lowest point of a reservoir trap that may retain hydrocarbons. Once a reservoir trap is filled to an associated spill point, further storage or retention of hydrocarbons may not occur for lack of reservoir space within the reservoir trap. In this case, the hydrocarbons may spill or leak out and migrate to another reservoir trap. In some reservoirs, some reservoir traps may be proximate one another and/or have a common spill point there between (i.e., related reservoir traps), such that hydrocarbons spilling from a first reservoir trap by way of a common spill point may be trapped in a second reservoir trap that is associated with the common spill point.

In some embodiments, related traps may be merged to form an effective trap that is representative of the related reservoir traps, but reflects a different estimation of oil and gas volume retained in the related reservoir traps Similarly, the corresponding catchment areas may also be merged to form an effective catchment area. An effective trap size based on the effective trap and an effective catchment area size based on the effective catchment area may be used in oil and gas subsurface modeling and prospecting. In some embodiments, the effective trap size may be larger than the sum of individual trap sizes of the related reservoir traps. In general, the merging of related reservoir traps and their corresponding catchment areas, and the determination of the effective trap size and the effective catchment area size may be based at least in part on the structural spill points and rules associated with the spilling and back spilling of hydrocarbons for proximate structures (e.g., related reservoir traps) having a common spill point. In these embodiments, structural spill points may be analyzed to determine an overall spill point for the related reservoir traps based on a depth associated with each structural spill point. Based on the overall spill point, the related reservoir traps and their catchment areas may be merged, and the effective trap size may be determined based at least in part on the overall spill point. The effective catchment area size may be determined from the effective trap. In some embodiments, the effective trap size may correspond to a volume, where such volume may be used to estimate a volume of hydrocarbons trapped in the one or more related reservoir traps corresponding to the effective trap.

One or more embodiments may utilize the effective trap size and the effective catchment area size associated with a reservoir for quantifying possible oil and gas resources for a reservoir, estimating oil and gas resources prior to drilling, modeling the oil and gas reservoir, and/or other such oil and gas exploration related computer implemented processes. Other variations and modifications will be apparent to one of ordinary skill in the art.

Oilfield Operations

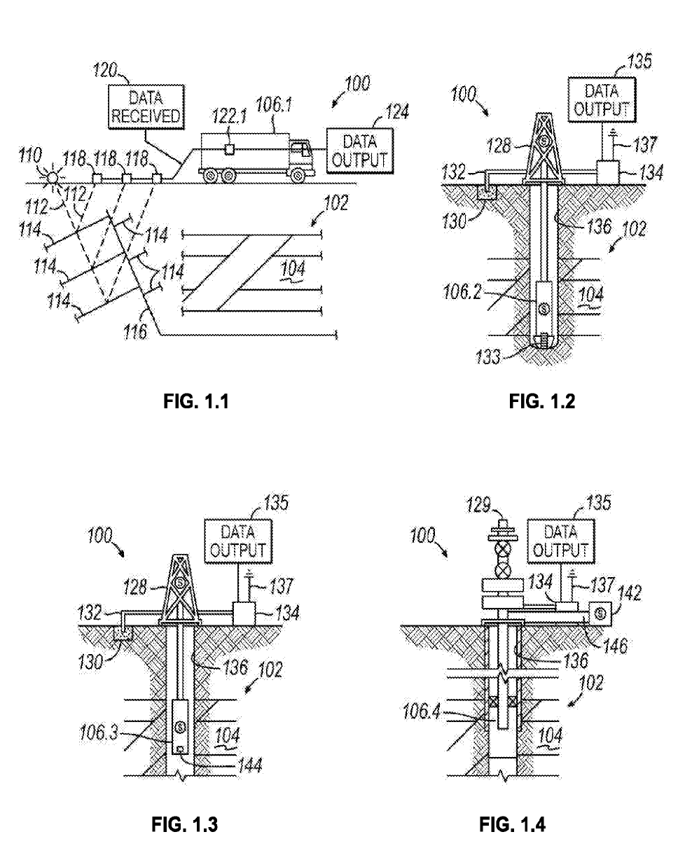

FIGS. 1.1-1.4 illustrate simplified, schematic views of an oilfield 100 having subterranean formation 102 containing reservoir 104 therein in accordance with implementations of various technologies and techniques described herein. FIG. 1.1 illustrates a survey operation being performed by a survey tool, such as seismic truck 106.1, to measure properties of the subterranean formation. The survey operation is a seismic survey operation for producing sound vibrations. In FIG. 1.1, one such sound vibration, sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 1.2 illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is generally filtered and returned to the mud pit. A circulating system may be used for storing, controlling, or filtering the flowing drilling muds. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produces data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Generally, the wellbore is drilled according to a drilling plan that is established prior to drilling The drilling plan generally sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected.

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize portions of the field operation, such as controlling drilling, weight on bit, pump rates, or other parameters. These adjustments may be made automatically based on computer protocol, and/or manually by an operator. In some cases, well plans may be adjusted to select optimum operating conditions, or to avoid problems.

FIG. 1.3 illustrates a wireline operation being performed by wireline tool 106.3 suspended by rig 128 and into wellbore 136 of FIG. 1.2. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein. In general, wireline tool 106.3 may thereby collect acoustic data and/or image data for a subsurface volume associated with a wellbore.

Wireline tool 106.3 may be operatively connected to, for example, geophones 118 and a computer 122.1 of a seismic truck 106.1 of FIG. 1.1. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 1D illustrates a production operation being performed by production tool 106.4 deployed from a production unit or christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106.4 or associated equipment, such as christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1.2-1.4 illustrate tools used to measure properties of an oilfield, it will be appreciated that the tools may be used in connection with non-oilfield operations, such as gas fields, mines, aquifers, storage, or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 1.1-1.4 are intended to provide a brief description of an example of a field usable with oilfield application frameworks. Part, or all, of oilfield 100 may be on land, water, and/or sea. Also, while a single field measured at a single location is depicted, oilfield applications may be utilized with any combination of one or more oilfields, one or more processing facilities and one or more wellsites.

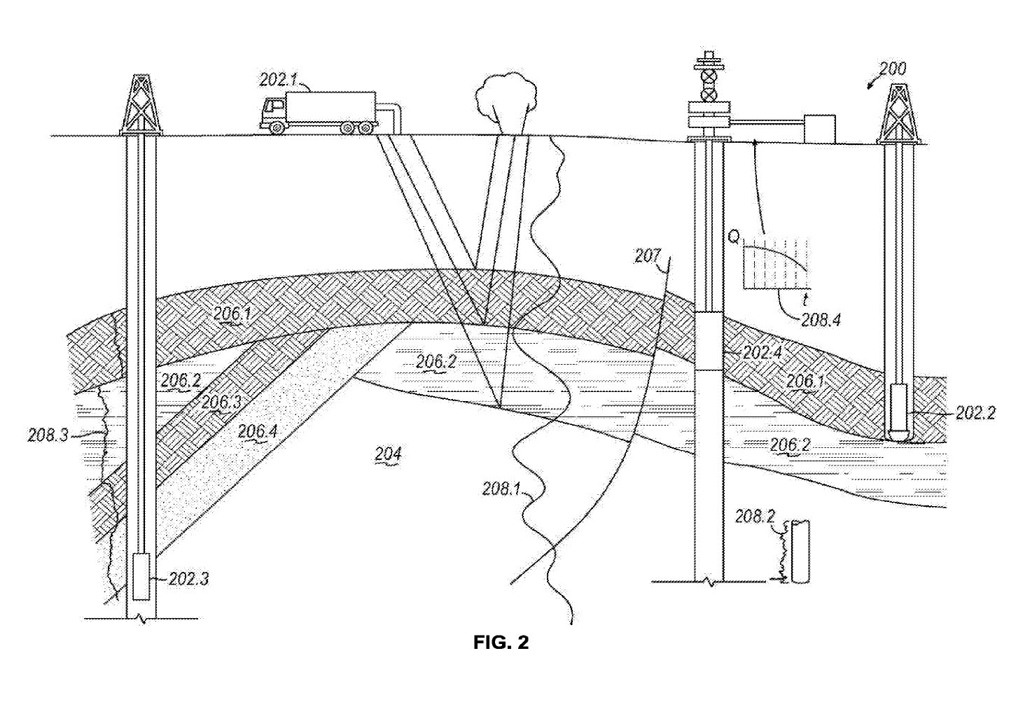

FIG. 2 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 1.1-1.4, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively, however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that generally provides a resistivity or other measurement of the formation at various depths.

A production decline curve or graph 208.4 is a dynamic data plot of the fluid flow rate over time. The production decline curve generally provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, generally below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Generally, seismic data displayed in static data plot 208.1 from data acquisition tool 202.1 is used by a geophysicist to determine characteristics of the subterranean formations and features. The core data shown in static plot 208.2 and/or log data from well log 208.3 are generally used by a geologist to determine various characteristics of the subterranean formation. The production data from graph 208.4 is generally used by the reservoir engineer to determine fluid flow reservoir characteristics. The data analyzed by the geologist, geophysicist and the reservoir engineer may be analyzed using modeling techniques.

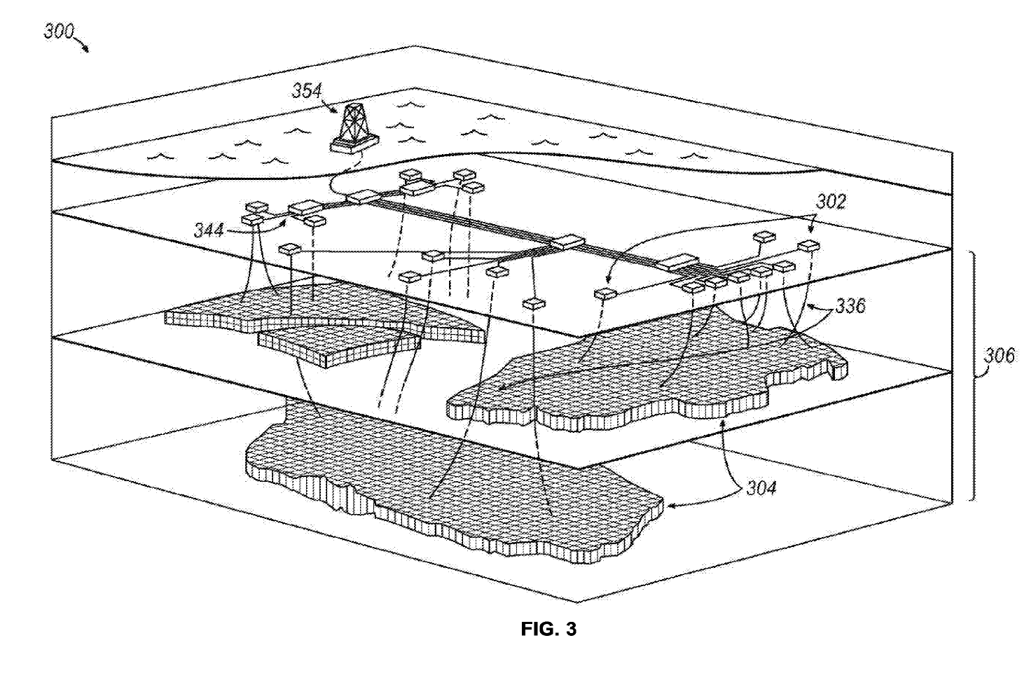

FIG. 3 illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3 is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

Reservoir Effective Trap and Effective Catchment Area Modeling

In general, one or more embodiments may determine effective traps and effective catchment areas that correspond to related reservoir traps of an oil and gas reservoir. An effective trap size may be determined based on the effective trap that generally corresponds to a hydrocarbon volume that may be trapped in the related reservoir traps. The effective catchment area size may be determined based on the effective trap size and the sizes of the individual catchment areas corresponding to the related reservoir traps. Accordingly, the effective trap size and the effective catchment area size may be used to estimate hydrocarbon volume, economic values, and/or other such characteristics of the reservoir for oil and gas prospecting.

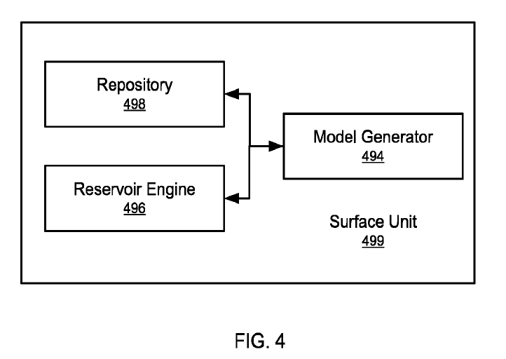

FIG. 4 shows a surface unit 499 in accordance with one or more embodiments. Surface unit 499 may be essentially the same as surface unit 134, discussed above in reference to FIGS. 1.1-1.4. As shown in FIG. 4, the surface unit 499 has multiple components including a repository 498, a reservoir engine 496, and a model generator 494. Each of these components (494, 496, 498) may be located on the same or different computing devices (e.g., server, mainframe, personal computer (PC), tablet computer, kiosk, smart phone, etc.). One or more of the components (494, 496, 498) may be connected by a network of any size having wired and/or wireless segments. One or more of the components (494, 496, 498) may be located in the cloud.

In one or more embodiments, the surface unit 499 includes the repository 498. The repository 498 may be implemented in hardware (e.g., circuitry), software, firmware, or any combination thereof. The repository 498 may be implemented as a database, a flat file, a lookup table, or any other data structure. In one or more embodiments, the repository 498 stores geological values associated with an oil and gas reservoir. One or more of these geological values may be obtained from sensors or tools (discussed above) in the oilfield. One or more of these geological values may be obtained from simulations or models of the oilfield. One or more of these geological values may be obtained from oilfield personnel (e.g., operators, petroleum engineers, geophysicists, etc.). One or more of these geological values may be measurements of various features of the reservoir and/or the oilfield.

In one or more embodiments, the surface unit 499 includes the reservoir engine 496. The reservoir engine 496 may be implemented in hardware (e.g., circuitry), software, firmware, or any combination thereof. In one or more embodiments, the reservoir engine 496 is configured to identify catchment areas associated with the reservoir based on the plurality of geological data values. The reservoir engine 496 may also identify a plurality of spill points for the reservoir based on the catchment areas. Further still, the reservoir engine 496 may identify reservoir traps for the reservoir based on the plurality of spill points and the plurality of catchment areas. Further still, the reservoir engine 496 may also determine effective trap sizes and multiple effective catchment area sizes based on the reservoir traps and the catchment areas (discussed below).

In one or more embodiments, the surface unit 499 includes the model generator 494. The model generator 494 is configured to generate a basin model associated with the reservoir that includes an indicator of the effective trap size and an indicator of the effective catchment area size. The model generator 494 may also be configured to generate a visualization of the basin model for output on a display or printer.

Although FIG. 4 shows a surface unit 499 having only three components (494, 496, 498), those skilled in the art, having the benefit of this detailed description, will appreciate that the surface unit 499 may have more or fewer components in other embodiments. Further, one or more of the components may be duplicated.

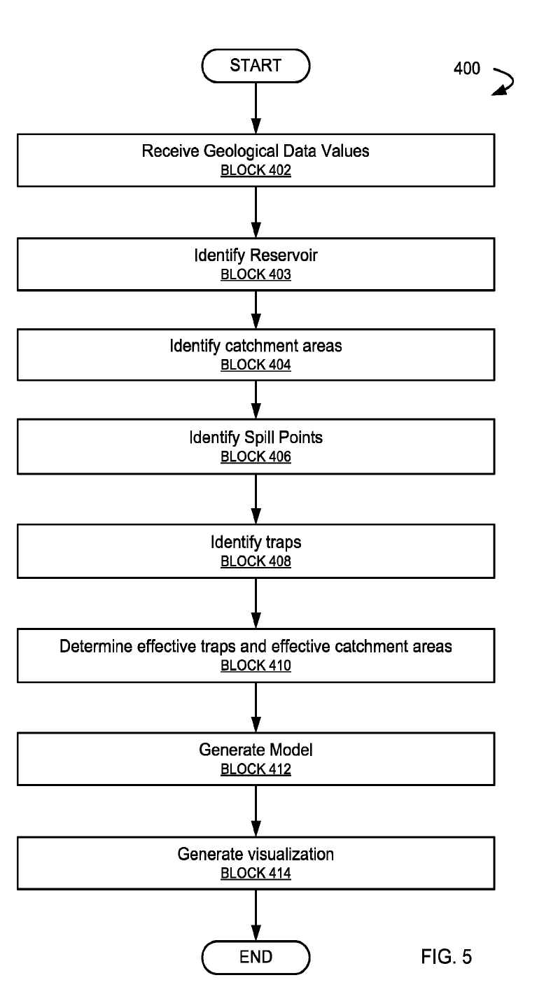

Turning now to FIG. 5, this figure provides flowchart 400 that illustrates a sequence of operations that may be performed by a computing device(s) (e.g., surface unit 499) to determine an effective trap size associated with a reservoir and an effective catchment area size. As shown, geological data may be received by the computing system (block 402). The geological data may be analyzed to identify the reservoir (block 403). In general, the reservoir (also referred to as a reservoir layer) may be defined by an upper and lower seal (also referred to as a sealing region) that comprises impermeable structures which impede the escape of hydrocarbons from the reservoir. In block 404, catchment areas are calculated from the analysis of possible migration routes within the reservoir. Each point of the reservoir, just below the seal may be examined to identify possible flow paths. All possible flow paths ending in the same “high point” (e.g., local peak) belong to the same catchment area and the same trap. The starting points of the possible flow paths define the catchment area (also called drainage area). The geological data may be analyzed to identify spill points associated with the reservoir (block 406). Based on the spill points and catchment areas, reservoir traps may be identified (block 408). Each catchment area is just below its corresponding reservoir trap (i.e., each catchment area is below the reservoir). Based on the spill points, the reservoir traps, and the corresponding catchment areas, one or more effective traps and one or more effective catchment areas may be determined (block 410). Each effective trap is the merger of two or more related reservoir traps, while each effective catchment area is the merger of the catchment areas corresponding to the related reservoir traps (i.e., the union of all the points defining the different catchment areas). The sizes of the effective traps and the effective catchment areas are also calculated based on the geological data values and the spill points. As catchment areas cannot overlap (one point cannot be the starting point for different flow paths) the size of an effective catchment area is the sum of the sizes of the corresponding related catchment areas. In some embodiments, a reservoir model that includes an indicator for each effective trap, each effective catchment area, each identified spill point, and/or each effective trap size and effective catchment area size may be generated (block 412). In these embodiments, a visualization of the model may be generated (block 414) for output to a display or printer of a computing system for review by a user.

FIG. 6 provides a flowchart 450 that illustrates a sequence of operations that may be performed by a computing device(s) (e.g., surface unit 499) to analyze a reservoir based at least in part on the effective trap sizes and corresponding effective catchment areas. In block 454, a hydrocarbon based compound value for the reservoir is determined (block 454). This determination may include performing a convolution on each effect trap and its corresponding effective catchment area. In general, hydrocarbon based compounds includes oil and resources. Therefore, embodiments may estimate a value of oil and gas of the reservoir based at least in part on the effective trap sizes and the effective catchment area sizes, where such value may refer to a volume or other such measurement used in oil and gas exploration. Based on the effective trap sizes, the effective catchment area sizes, and the hydrocarbon based compound value, an economic value for the reservoir is determined (block 456). For example, a monetary value may be determined for the reservoir. In some embodiments, the reservoir may be ranked (block 458) relative to a plurality of other reservoirs for which an economic value has been determined based at least in part on effective trap sizes and effective catchment area sizes. Furthermore, in some embodiments associated with oil and gas prospecting and exploration, embodiments may determine a chance of success associated with the reservoir (block 460) based at least in part on the effective trap sizes and the effective catchment area sizes. In general, the chance of success may be used in various prospecting analysis and modeling to determine whether to develop an oil field associated with the reservoir.

FIG. 7 provides a flowchart 500 that illustrates a sequence of operations that may be performed by a computing device(s) (e.g., surface unit 499) to determine an effective trap size for related reservoir traps and an effective catchment area size based on identified spill points and identified reservoir traps for an oil and gas reservoir. A seal for the reservoir may be identified based on the geological data (block 504). In general, a seal (also referred to as cap rock) corresponds to an impermeable structure that forms the upper limit of the oil and gas reservoir by impeding the escape of hydrocarbons from reservoir rock. In block 505, catchment areas are calculated from the analysis of possible migration routes within the reservoir. Each point of the reservoir, just below the seal, may be examined to identify possible flow paths. All possible flow paths ending in the same “high point” (e.g., local peak) belong to the same catchment area and the same trap. The starting points of the possible flow paths define the catchment area. A depth may be determined for each spill point (block 506). Based on the identified spill points and the reservoir traps, common spill points may be determined (block 508). As discussed, two or more reservoir traps may share and/or be proximate to a spill point (referred to as a common spill point), such that oil and gas may spill between the two or more reservoir traps via the common spill point. One of the reservoir traps may be a micro-structure (discussed below).

Based on the reservoir analysis common structural spill points, related reservoir traps and their corresponding catchment areas may be determined (block 510), where related reservoir traps generally refer to reservoir traps that share and/or are proximate a spill point. The related reservoir traps and their corresponding catchment areas are merged to form an effective trap and an effective catchment area (block 512). An overall spill point is determined for each effective trap (block 514), where the overall spill point is determined based at least in part on a depth of the spill points associated with the related reservoir traps. In general, the overall spill point corresponds to the spill point at which hydrocarbons will spill from the related reservoir traps. A contact area may be determined for each effective trap (block 516). The contact area generally refers to a defining limit between water and hydrocarbons in the reservoir. In general, hydrocarbons are less dense than water in a reservoir such that the hydrocarbons are above water in the reservoir, and therefore, the contact area defines a lower limit of hydrocarbons in the reservoir. Based on the overall spill point, the seal, and the contact area, an effective trap size and an effective catchment area size for each set of merged reservoir traps is determined (block 518). In general, the effective trap size may be a volume that is defined by the upper limit of the seal and the lower limit of the overall spill point. In general, the effective catchment area size may be calculated from all surrounding points which are directly connected by an upward path below the seal to the top of the structure.

In one or more embodiments, following Block 518, the process returned to Block 506. In other words, the process is recursive. Existing merged traps may be merged with other already merged traps to form new effective traps and their corresponding catchment areas.

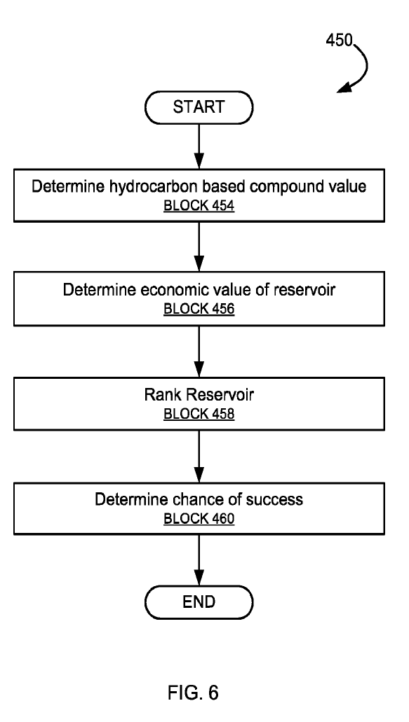

FIG. 8 provides a functional depth view of the characteristics an example reservoir 600. As shown, a seal 602 (also referred to as a sealing region) may form an upper limit, and a contact area 604 (illustrated as a dashed line) may represent a lower limit for hydrocarbons in the reservoir 600. In this example, the reservoir 600 includes a first reservoir trap 608 and a second reservoir trap 610 that have a common spill point 612 therebetween. There is also a first catchment area 694 and a second catchment area 692 corresponding to the first reservoir trap 608 and the second reservoir trap 610, respectively. In this example reservoir 600, an overall spill point 614 corresponds to the structural spill point at which hydrocarbons will escape the two reservoir traps 608, 610. Those skilled in the art, having the benefit of this detailed description, will appreciate that the amount of oil, migrating from the source rock upwards into the reservoir, which could be captured in each trap 608, 610, is strongly dependent on the size of each catchment area 692, 694.

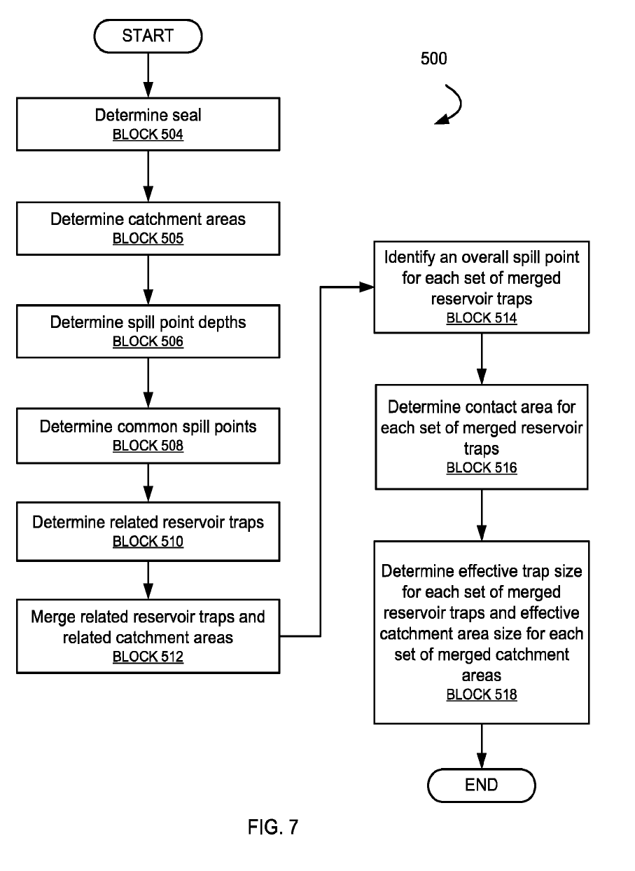

Similarly, FIG. 9 provides a depth view of the characteristics of an example reservoir 650 having a seal 652 and a contact area 654 defining a volume that may store hydrocarbons. A first reservoir trap 656 and a second reservoir trap 658 share a common spill point 660 (i.e., the first and second reservoir traps are related reservoir traps and thus can be merged to form an effective trap). An effective catchment area 695 can be calculated for the effective trap. The effective trap is larger than the sum of the individual traps 608, 610. Similarly, the effective catchment area 695 is larger than the individual catchment areas 692, 694 corresponding to the individual traps 608, 610. An overall spill point 662 corresponds to the structural spill point at which hydrocarbons will escape the two reservoir traps 658, 660.

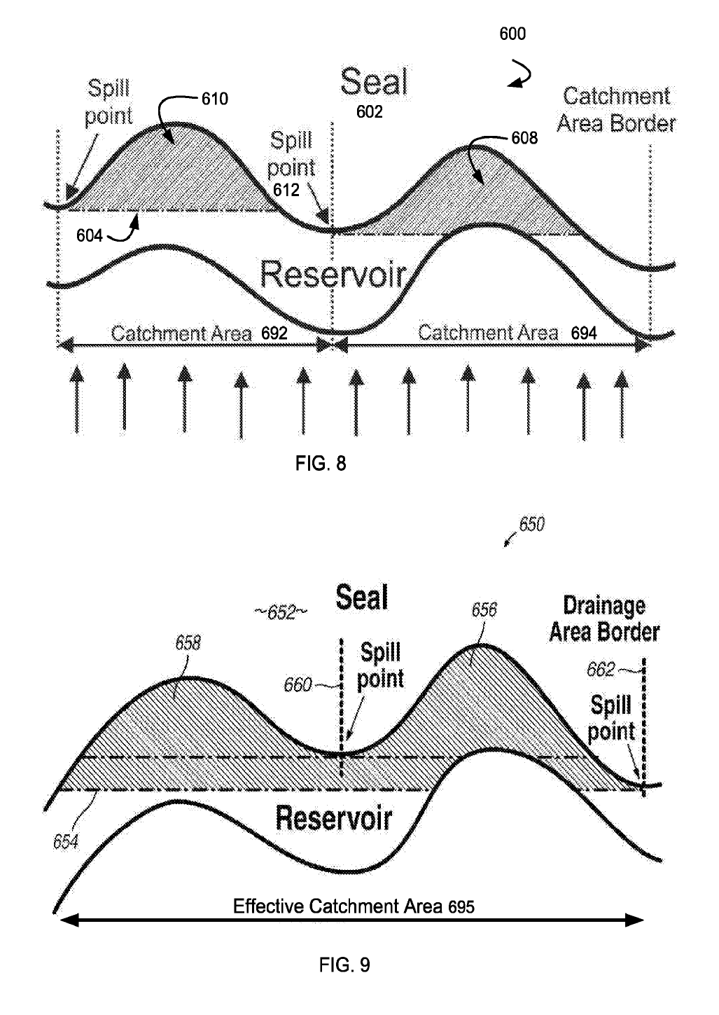

FIG. 10 provides a depth view of the characteristics of an example reservoir 700 that includes a seal 702 and a contact area 704 that represents an upper and lower limit for a volume of hydrocarbons that may be stored by the reservoir 700. The reservoir 700 includes a first reservoir trap 706 and a second reservoir trap 708 (also referred to as a microstructure) that share a common spill point 710 such that the first reservoir trap 706 and the second reservoir trap 708 are related. In this example, the overall spill point 712 corresponds to the structural spill point at which hydrocarbons will spill out of the related reservoir traps 706, 708. The effective trap has an effective catchment area 799. Those skilled in the art, having the benefit of this detailed description, will appreciate that the microstructure 708 (i.e., a trap having a volume less than a threshold) by itself may contain an uneconomically small value of oil. However, by merging the microstructure 708 with the first reservoir trap 706, the resulting effective trap size and corresponding effective catchment area size might capture much more oil coming from a source rock.

Therefore, in the examples provided in FIGS. 8-10, according to embodiments, the related reservoir traps may be merged into an effective trap, and an effective trap size may be determined. Similarly, the catchment areas corresponding to the related reservoir traps may also be merged into an effective catchment area, and an effective catchment area size may be determined. As can been seen in the examples, in some reservoirs, an effective trap size and an effective catchment area size may more accurately estimate a volume of hydrocarbons held by the reservoir as compared to an estimation of the volume of hydrocarbons based upon a size of the reservoir traps and catchment areas individually. Therefore, consistent with some embodiments, a determination of hydrocarbon volume stored in a reservoir may be based on effective trap sizes and effective catchment area sizes.

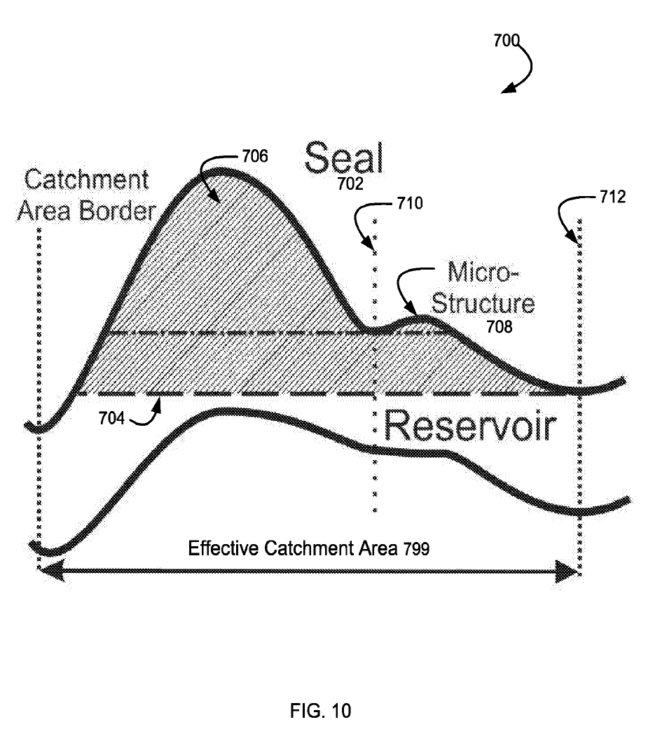

Based at least in part on the determined hydrocarbon volume, embodiments may evaluate a reservoir for a chance of success for finding and extracting oil and gas resources from the reservoir. Furthermore, the reservoir may be ranked relative to other reservoirs based on the chance of success and/or other economic values that may be determined based on the effective trap size. FIG. 11 provides an example chart 750 that provides maps grouped with geological features that are mapped to a corresponding image on a chance of success (COS) with a scale from zero to one that corresponds to a chance of a basin having oil and gas resources that may be extracted.

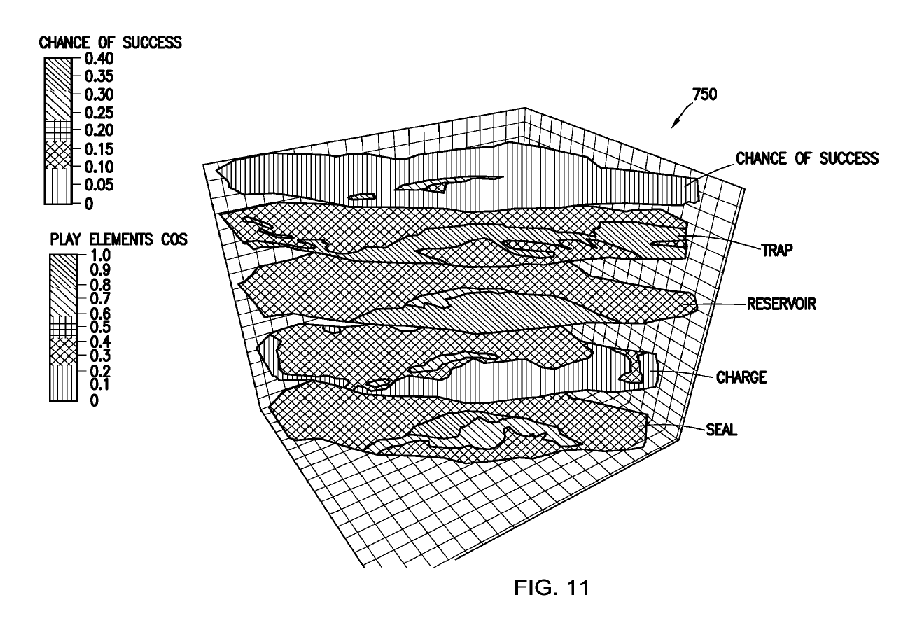

FIG. 12 provides an example graphical user interface 850 that may be output to a display of a computing system consistent with some embodiments. In this example, a user may select one or more geological features/characteristics 852 of a prospect (e.g., a basin or reservoir) to analyze and model to determine a chance of success for oil and gas exploration for the basin and/or reservoir. In the example, charge features, reservoir features, seal features, trap features, catchment area features, and/or preservation features of the basin and/or reservoir may be utilized in determining a chance of success for oil and gas exploration.

As should be appreciated, some oil and gas reservoirs may comprise a plurality of reservoir traps with corresponding catchment areas, which may or may not be related. As such, embodiments may determine one or more effective traps for the reservoir for one or more groups of related reservoir traps. Similarly, embodiments may determine one or more effective catchment areas for the one or more groups of related catchment areas. Accordingly, an effective trap size of a reservoir may be based on one or more effective trap sizes determined for one or more related reservoir traps. Similarly, an effective catch size for the reservoir may be based on one or more effective trap sizes determined for the related catchment areas corresponding to the related traps.

Accordingly, some embodiments may include one or more of a method, computing device, computer-readable medium, and system for determining effective trap size and an effective catchment area size for prospect risking. Some embodiments comprise a chance of successful exploration determination (i.e., chance of success) that may be determined with one or more computer implemented methods based at least in part on effective trap sizes and effective catchment sizes. The determination of a chance of success may be referred to as “play to prospect risk analysis”, “play chance mapping”, “play chance assessment” or “exploration geology analysis”. Additional details regarding reservoirs, reservoir traps, and various characteristics thereof may be found, for example, in T. Hantschel & A. I. Kauerauf: Fundamentals of Basin and Petroleum Systems Modeling, Springer 2009, which is incorporated by reference herein.

As discussed, some embodiments may include the calculation of structural spill points and a merger of reservoir traps and catchment areas according to rules based on spilling and back spilling from nearby structures which share the same spill point. In such situations a merging of structures (i.e., reservoir traps, catchment areas) and calculation/re-calculation of oil and/or gas storage volume may be involved for a more accurate estimation of effective trap sizes and effective catchment area sizes. Effective trap sizes and effective catchment area sizes can be taken into account in a convolution procedure of the risk assessment, which may allow for an improved quantification of the possible petroleum (i.e., hydrocarbons, oil and gas resources) in place and thus for an improved chance of successful exploration as compared to quantifications based on individual analysis of reservoir traps and their corresponding catchment areas. Hence, a chance of finding oil and gas in exploration can be estimated for prospects before drilling based on the effective trap sizes and the effective catchment area sizes. The chance of success may be calculated in a risking procedure based on some geological features such as seal and reservoir quality, petroleum generation potential, effective trap size, effective catchment area size, etc.

In general, trap sizes may be calculated by searching of structural spill points, i.e. of potentially completely filled structures. Hydrocarbons (e.g., petroleum) are generally lighter than surrounding water in a reservoir. A contact area between water and petroleum may generally be considered to be a flat, horizontal meniscus and thus trap size can be calculated by numerical evaluation of the volume between the seal above the flat meniscus within a reservoir (e.g., the shaded areas of the reservoir traps 608, 610 of FIG. 8). The catchment area is the area just below the reservoir trap (i.e., the catchment area is below the reservoir). The catchment area may be calculated from all surrounding points which are directly connected by an upward path below the seal to the top of the structure.

When, however, reservoir traps share a structural spill point (i.e., related reservoir traps), overcharging of these two structures (i.e., merging) with oil can lead to one accumulation covering both traps (see e.g., FIG. 9) (a merged or effective trap). In this case, the depth of oil and gas may be given by the overall spill point (e.g., spill point 662 of FIG. 9). The volume (i.e., effective size) of the merged reservoir traps may then be based on the overall spill point, as compared to the individual spill points of the related reservoir traps. Hence, in the example shown in FIG. 9, the effective trap size may be larger than the sum of the separate reservoir traps (the example shown in FIG. 8).

Determining effective trap size may comprise calculating spill points and corresponding depths, searching spill points which are common to at least two reservoir traps, defining effective traps, and calculating an effective trap size based on a volume between a reservoir seal and a depth of an overall spill point. Consistent with embodiments, basin modeling, reservoir modeling, chance of success assessments, and/or other such oil and gas prospecting procedures may be based at least in part on effective trap sizes and their corresponding effective catchment areas associated with one or more reservoirs.

It will be appreciated that determination of trap sizes or volumes of effective traps based upon overall spill points would be well within the abilities of one of ordinary skill in the art having the benefit of the instant disclosure, as would implementation of the herein-described techniques in a computer system.

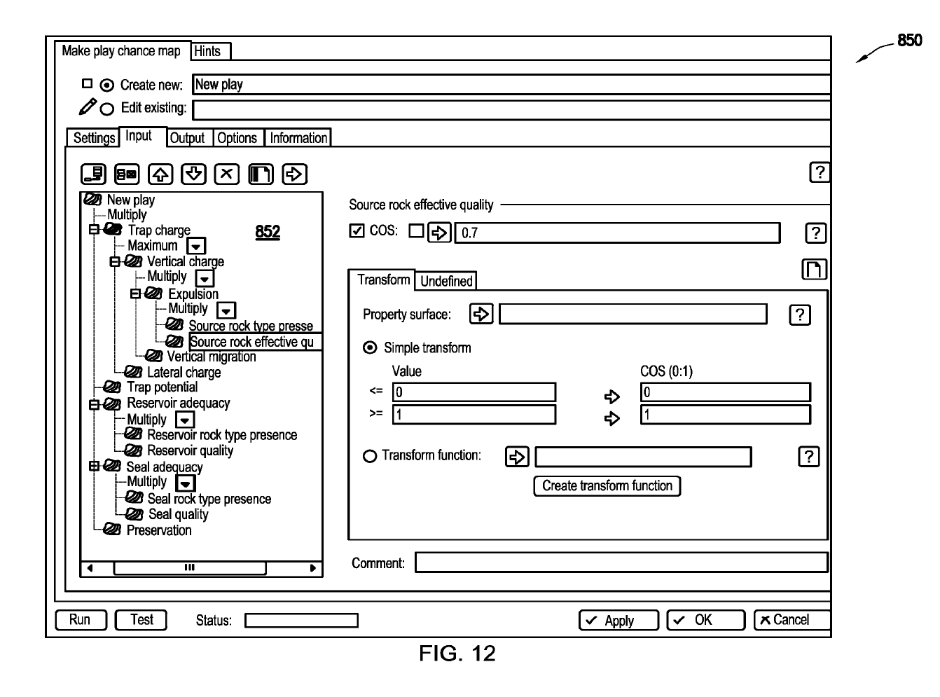

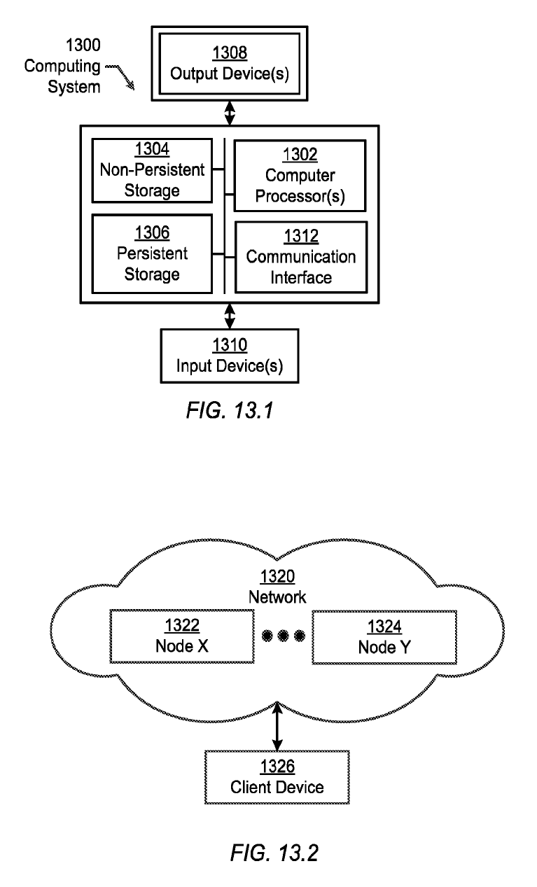

Embodiments may be implemented on a computing system. Any combination of mobile, desktop, server, router, switch, embedded device, or other types of hardware may be used. For example, as shown in FIG. 13.1, the computing system (1300) may include one or more computer processors (1302), non-persistent storage (1304) (e.g., volatile memory, such as random access memory (RAM), cache memory), persistent storage (1306) (e.g., a hard disk, an optical drive such as a compact disk (CD) drive or digital versatile disk (DVD) drive, a flash memory, etc.), a communication interface (1312) (e.g., Bluetooth interface, infrared interface, network interface, optical interface, etc.), and numerous other elements and functionalities.

The computer processor(s) (1302) may be an integrated circuit for processing instructions. For example, the computer processor(s) may be one or more cores or micro-cores of a processor. The computing system (1300) may also include one or more input devices (1310), such as a touchscreen, keyboard, mouse, microphone, touchpad, electronic pen, or any other type of input device.

The communication interface (1312) may include an integrated circuit for connecting the computing system (1300) to a network (not shown) (e.g., a local area network (LAN), a wide area network (WAN) such as the Internet, mobile network, or any other type of network) and/or to another device, such as another computing device.

Further, the computing system (1300) may include one or more output devices (1308), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (1302), non-persistent storage (1304), and persistent storage (1306). Many different types of computing systems exist, and the aforementioned input and output device(s) may take other forms.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments.

The computing system (1300) in FIG. 13.1 may be connected to or be a part of a network. For example, as shown in FIG. 13.2, the network (1320) may include multiple nodes (e.g., node X (1322), node Y (1324)). Each node may correspond to a computing system, such as the computing system shown in FIG. 13.1, or a group of nodes combined may correspond to the computing system shown in FIG. 13.1. By way of an example, embodiments may be implemented on a node of a distributed system that is connected to other nodes. By way of another example, embodiments may be implemented on a distributed computing system having multiple nodes, where each portion of the embodiment may be located on a different node within the distributed computing system. Further, one or more elements of the aforementioned computing system (1300) may be located at a remote location and connected to the other elements over a network.

Although not shown in FIG. 13.2, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (1322), node Y (1324)) in the network (1320) may be configured to provide services for a client device (1326). For example, the nodes may be part of a cloud computing system. The nodes may include functionality to receive requests from the client device (1326) and transmit responses to the client device (1326). The client device (1326) may be a computing system, such as the computing system shown in FIG. 13.1. Further, the client device (1326) may include and/or perform all or a portion of one or more embodiments.

The computing system or group of computing systems described in FIGS. 13.1 and 13.2 may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes. The processes may be part of the same or different application and may execute on the same or different computing system.

Rather than or in addition to sharing data between processes, the computing system performing one or more embodiments may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments, may extract one or more data items from the obtained data. For example, the extraction may be performed as follows by the computing system in FIG. 13.1. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail—such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 13.1, while performing one or more embodiments, may perform data comparison. Data comparison may be used to compare two or more data values (e.g., A, B). For example, one or more embodiments may determine whether A>B, A=B, A!=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments, A and B may be vectors, and comparing A with B requires comparing the first element of vector A with the first element of vector B, the second element of vector A with the second element of vector B, etc. In one or more embodiments, if A and B are strings, the binary values of the strings may be compared.

The computing system in FIG. 13.1 may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 13.1 may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions present only a few examples of functions performed by the computing system of FIG. 13.1 and the nodes and/or client device in FIG. 13.2. Other functions may be performed using one or more embodiments.

The terminology used herein is for the purpose of describing particular embodiments only and is not intended to be limiting of the embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising.”

While various embodiments have been described in considerable detail, it is not the intention of the Applicant to restrict or in any way limit the scope of the appended claims to such detail. For example, the operations represented by blocks of the flowcharts included herein may be reorganized, performed concurrently, and/or sequentially in any order. Additional advantages and modifications will readily appear to those skilled in the art. Other embodiments are not limited to the specific details, representative apparatus and method, and illustrative examples shown and described. Accordingly, departures may be made from such details without departing from the spirit or scope of the Applicant's general inventive concept.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for managing a reservoir, comprising:
receiving a plurality of geological data values associated with the reservoir;
identifying a plurality of catchment areas associated with the reservoir based on the plurality of geological data values;
identifying a plurality of spill points for the reservoir based on the plurality of catchment areas;
identifying a plurality of reservoir traps for the reservoir based on the plurality of spill points and the plurality of catchment areas; and
determining a plurality of effective trap sizes and a plurality of effective catchment area sizes based on the plurality of reservoir traps and the plurality of catchment areas.

2. The method of claim 1, further comprising:
determining an economic value of the reservoir based on the plurality of effective trap sizes and the plurality of effective catchment area sizes.

3. The method of claim 2, further comprising:
ranking the reservoir relative to a plurality of other reservoirs based on the economic value.

4. The method of claim 1, wherein determining the plurality of effective trap sizes and the plurality of effective catchment area sizes comprises:
merging a subset of the plurality of reservoir traps and a subset of the plurality of catchment areas separated by a spill point of the plurality of spill points;
determining an effective trap size for the merged reservoir traps; and
determining an effective catchment area size for the merged catchment areas.

5. The method of claim 4, wherein:
the subset of catchment areas comprises a first catchment area and a second catchment area;
identifying the first catchment area comprises identifying a first plurality of starting points for a plurality of flow paths ending at the same local peak in the reservoir; and
the first plurality of starting points define the first catchment area.

6. The method of claim 5, wherein:
determining the effective trap size for the merged reservoir traps comprises executing a union of the first plurality of starting points with a second plurality of starting points defining the second catchment area.

7. The method of claim 1, wherein determining the plurality of effective trap sizes associated with the reservoir comprises:
identifying a pair of related reservoir traps from among the plurality of reservoir traps;
identifying an overall spill point for the pair of related reservoir traps based on a depth of a structural spill point associated with at least one of the pair of related reservoir traps; and
determining an effective trap size for the pair of related reservoir traps based at on a depth of the overall spill point,
wherein at least one of the plurality effective catchment area sizes is based on the union of the catchment areas of the pair of related reservoir traps.

8. The method of claim 7, wherein one of the pair of related reservoir traps is a micro-structure.

9. The method of claim 1, further comprising:
generating a basin model associated with the reservoir that includes an indicator of the plurality of effective trap sizes and an indicator of the plurality of effective catchment area sizes; and
generating a visualization of the basin model that includes a visualization of the reservoir, the indicator of the plurality of effective trap sizes, and the indicator of the plurality of effective catchment area sizes for output on a display.

10. The method of claim 1, further comprising:
determining a chance of success associated with the reservoir based at least in part on the plurality of effective trap sizes and the plurality of effective catchment area sizes.

11. A system for managing a reservoir, comprising:
a processor;
a repository storing a plurality of geological data values associated with the reservoir;
a reservoir engine executing on the processor that:
identifies a plurality of catchment areas associated with the reservoir based on the plurality of geological data values;
identifies a plurality of spill points for the reservoir based on the plurality of catchment areas;
identifies a plurality of reservoir traps for the reservoir based on the plurality of spill points and the plurality of catchment areas; and
determines a plurality of effective trap sizes and a plurality of effective catchment area sizes based on the plurality of reservoir traps and the plurality of catchment areas; and
a model generator that:
generates a basin model associated with the reservoir that includes an indicator of the plurality of effective trap sizes associated with the reservoir and an indicator of the plurality of effective catchment area sizes; and
generates a visualization of the basin model for output on a display.

12. The system of claim 11, wherein determining the plurality of effective trap sizes and the plurality of effective catchment area sizes comprises:
merging a subset of the plurality of reservoir traps and a subset of the plurality of catchment areas separated by a spill point of the plurality of spill points;
determining an effective trap size for the merged reservoir traps; and
determining an effective catchment area size for the merged catchment areas.

13. The system of claim 12, wherein:
the subset of catchment areas comprises a first catchment area and a second catchment area;
identifying the first catchment area comprises identifying a first plurality of starting points for a plurality of flow paths ending at the same local peak in the reservoir; and
the first plurality of starting points define the first catchment area.

14. The system of claim 13, wherein:
determining the effective trap size for the merged reservoir traps comprises executing a union of the first plurality of starting points with a second plurality of starting points defining the second catchment area.

15. The system of claim 11, wherein determining the plurality of effective trap sizes associated with the reservoir comprises:
identifying a pair of related reservoir traps from among the plurality of reservoir traps;
identifying an overall spill point for the pair of related reservoir traps based on a depth of a structural spill point associated with at least one of the pair of related reservoir traps; and
determining an effective trap size for the pair of related reservoir traps based at on a depth of the overall spill point,
wherein at least one of the plurality of effective catchment area sizes is based on the union of the catchment areas of the pair of related reservoir traps.

16. A non-transitory computer readable medium (CRM) storing instructions for managing a reservoir, the instructions comprising functionality for:
receiving a plurality of geological data values associated with the reservoir;
identifying a plurality of catchment areas associated with the reservoir based on the plurality of geological data values;
identifying a plurality of spill points for the reservoir based on the plurality of catchment areas;
identifying a plurality of reservoir traps for the reservoir based on the plurality of spill points and the plurality of catchment areas; and
determining a plurality of effective trap sizes and a plurality of effective catchment area sizes based on the plurality of reservoir traps and the plurality of catchment areas;
determining an economic value of the reservoir based on the plurality of effective trap sizes and the plurality of effective catchment area sizes.

17. The non-transitory CRM of claim 16, wherein determining the plurality of effective trap sizes and the plurality of effective catchment area sizes comprises:
merging a subset of the plurality of reservoir traps and a subset of the plurality of catchment areas separated by a spill point of the plurality of spill points;
determining an effective trap size for the merged reservoir traps; and
determining an effective catchment area size for the merged catchment areas.

18. The non-transitory CRM of claim 17, wherein:
the subset of catchment areas comprises a first catchment area and a second catchment area;
identifying the first catchment area comprises identifying a first plurality of starting points for a plurality of flow paths ending at the same local peak in the reservoir;
the first plurality of starting points define the first catchment area; and
determining the effective trap size for the merged reservoir traps comprises executing a union of the first plurality of starting points with a second plurality of starting points defining the second catchment area.

19. The non-transitory CRM of claim 16, wherein determining the plurality of effective trap sizes associated with the reservoir comprises:
identifying a pair of related reservoir traps from among the plurality of reservoir traps;
identifying an overall spill point for the pair of related reservoir traps based on a depth of a structural spill point associated with at least one of the pair of related reservoir traps; and
determining an effective trap size for the pair of related reservoir traps based at on a depth of the overall spill point,
wherein at least one of the plurality of effective catchment area sizes is based on the union of the catchment areas of the pair of related reservoir traps.

20. The non-transitory CRM of claim 16, the instructions further comprising functionality for:
generating a basin model associated with the reservoir that includes an indicator of the plurality of effective trap sizes and an indicator of the plurality of effective catchment area sizes; and
generating a visualization of the basin model that includes a visualization of the reservoir, the indicator of the plurality of effective trap sizes, and the indicator of the plurality of effective catchment area sizes for output on a display.
